(19) United States
(12) Patent Application Publication
(10) Pub. No.: US 2004/0157079 A1
(43) Pub. Date: Aug. 12, 2004

(54) Method for forming a vibration-damping sheet or panel, and articles obtained therewith

(76) Inventor: Paolo Cittadini, Varese (IT)

Correspondence Address: JACOBSON HOLMAN, PROFESSIONAL LIMITED LIABILITY COMPANY, 400 SEVENTH STREET, N.W., WASHINGTON, DC, 20004, US

(21) Appl. No.: 10/359,551

(22) Filed: Feb. 7, 2003

(51) Int. Cl. B23P 25/00

(52) U.S. Cl. 428/544

(57) ABSTRACT

The present invention relates to a method for forming a vibration-damping sheet or panel to be joined to a sheet metal element, such as the bodywork of a motor vehicle, this sheet or panel being formed using a plurality of materials including at least a material having vibration-damping properties and a magnetic material, characterized in that it comprises the stages of forming a first layer which is operationally intended to come into contact with said sheet metal and in which substantially all of said magnetic material is included, forming a second layer comprising all or part of said material with vibration-damping properties and joining together said layers to form said sheet or panel.

### DESCRIPTION

The present invention relates to a method for forming a vibration-damping sheet or panel to be joined to a sheet metal element, such as the bodywork of a motor vehicle.

Vibration-damping sheets or panels to be fitted to motor vehicles, for eliminating or at least reducing the vibrations which are produced during the movement of the vehicle and transmitted to the various parts of the vehicle, especially when there is an increase in the travel speed, are known. Eliminating the cause of vibrations helps in particular reduce the noisiness within the passenger compartment, resulting in greater comfort for the passengers. Consequently these panels are also known as sound-deadening or noise-reducing panels.

For this reason, in the remainder of the present description, these vibration-damping sheets or panels or the associated materials which impart said property to the end product will in some cases, for the sake of brevity, be referred to as “soundproofing” panels.

These sheets or panels are mounted so as to be in contact with every part of the bodywork which is subject to vibration: bonnet, flooring, roof, bodywork, doors, and so on.

The soundproofing material generally consists of a mixture of bitumen and inorganic filler, usually in a composition together with other components and additives such as elastomers, resins, plasticizers and oils, which is homogeneously mixed and then formed into sheets by means of calendering or rolling.

These sheets are thus formed, shaped and made to adhere to the corresponding vehicle part, positioning them for example by means of an adhesive, which is necessary in particular when they must be arranged and kept in position on the sheet metal in positions different from a position which is horizontal or above the sheet metal, i.e. in a position which is vertical, inclined or underneath the roof.

During the various processing steps, for example oven spray-painting of the bodywork, under the effect of the heat the bitumen will melt and run, sealing all the interstices so as to be able to effectively perform a barrier function, and is stably bonded to the sheet metal after cooling and consolidation. During the abovementioned step, since errors may occur in the positioning of the sheet or panel during the course of provisional assembly, the fact of using an adhesive may give rise to a serious problem when detaching the soundproofing panel which has been incorrectly positioned on the vehicle part. In this case it is necessary to stop the vehicle production line, remove the incorrectly assembled part from the line and employ personnel in order to detach the panel from the door, often with serious difficulties since powerful adhesives are used.

In the past, therefore, sheets or panels of the type in question have been introduced, where the positioning is performed by means of magnetic attraction to the sheet metal elements of the vehicle, without the need for using adhesives: for this purpose, a magnetic material, generally magnetizable ferrite, which per se does not have soundproofing properties, is added to the composition of the material suitable for forming the panel.

The ferrite must be dispersed homogeneously in the mass of the mixture so as to be able to ensure a suitable effect of magnetic attraction to the sheet metal with which the sheet formed by said mixture must come into contact. However, only a part of the ferrite thus added is active, namely participates in the magnetic sealing action, whereas the remaining part (calculated as being nearly 60% of the ferrite used in the mixture), since it is homogeneously dispersed within the said mixture, is situated too far from the contact surface between sheet and sheet metal for it to be able to perform its function. This inactive part of ferrite therefore only unnecessarily increases the weight of the vehicle structure, as well as the manufacturing costs, while present-day car-manufacturing technology is looking for materials which are increasingly lighter so as to be able to improve the performance and consumption of the vehicle.

The main object of the present invention is to solve this problem and, to this end, it proposes a method for forming a vibration-damping sheet or panel to be joined to a sheet metal element, such as the bodywork of a motor vehicle, this sheet or panel being formed using a plurality of materials including at least a material having vibration-damping properties and a magnetic material, characterized in that it comprises the stages of forming a first layer which is operationally intended to come into contact with said sheet metal and in which substantially all of said magnetic material is included, forming a second layer comprising substantially all or part of said material with vibration-damping properties and joining together said layers so as to form said sheet or panel.

As the material with vibration-damping properties it is possible to use bitumen, with the possible addition of additives such as elastomers, plastomers, resins, oils, together with an inert filler chosen from among a wide range of materials such as, for example, mica, kaolin, talc, wood or cork dust, textile fibre, or mixtures thereof.

As an alternative it is possible to use plastic materials having vibration-damping properties such as polyurethane, on its own or mixed with other materials.

As the magnetic material it is possible to use any magnetizable material, such as ferrite or permanent-magnet powder, on its own or mixed with other substances such as, for example, metal oxides.

According to a main feature of the present invention, nearly all the magnetic material used is therefore placed in a layer formed independently and suitable for forming the layer facing the sheet metal during the operational step of fitting to the vehicle.

“Substantially all of said magnetic material” as used in the above definition is understood as meaning at least 90% of the magnetic material used overall.

As regards the said material with vibration-damping properties, it may be included both in the composition of the mixture of both said first layer and said second layer or substantially only of said second layer.

In order to form the finished sheet or panel according to the present invention, it is possible to envisage further layers combined with said at least two main layers, so as to provide the finished article with further advantageous properties.

According to an embodiment of the invention, said first layer is formed from a mixture of bitumen and all the magnetizable ferrite intended for manufacture of the finished sheet, subjecting it to calendering. Said layer thus formed may be wound onto reels and stored so as to be supplied to the user subsequently, or may be immediately hot-bonded to a second layer formed by means of calendering from a mixture comprising all or part of the material with vibration-damping properties, for example a mixture substantially based on bitumen and an inert filler such as mica, with any additional components. In this embodiment, the two layers are joined together by means of heat co-calendering while the bitumen which forms both the layers is in the softened state, such that the adhesion between the two bituminous layers in order to produce the final sheet or panel occurs stably by means of cooling and consolidation thereof.

According to a variant of the invention, the first layer containing the magnetic material, instead of being in the form of a sheet, may be formed or cut into strips which are joined to said second layer in a spaced arrangement.

In a different embodiment of the invention, the second layer may be formed for example in a mould and then joined to the said first layer containing the magnetic material by means of an adhesive or by means of co-moulding.

In a further embodiment, the second layer may be formed by means of spraying onto the first layer. These embodiments are applicable in particular to the case where the material with vibration-damping properties is polyurethane.

In a further embodiment, the two layers may be formed by means of extrusion and then joined together, or formed by means of co-extrusion.

An example of a practical embodiment of the method according to the invention is now described, said embodiment not being intended to be limiting.

### EXAMPLE

The following charge is mixed in a mixer

71% by weight of barium ferrite

25% by weight of bitumen

2% by weight of kaolin

2% by weight of talc

Mixing temperature: 85±5° C.

The product thus mixed is processed by means of calendering until a sheet having a thickness of about 1 mm which forms said first layer is obtained.

The said sheet is then joined by means of hot co-calendering (temperature of the rollers: 55±5° C.) to a second layer, thickness of about 1 mm, also obtained by means of calendering using the following formulation:

70% by weight of bitumen

15% by weight of kaolin

15% by weight of talc

Mixing temperature: 85±5° C.

This second sheet forms said layer and the combination of the said two sheets constitutes the finished sheet or panel.

According to the solution conceived and generally proposed here of concentrating nearly all the magnetic material exclusively on the surface layer of the sheet or panel intended to be arranged operationally facing the sheet metal, the invention consists in using only the quantity of magnetic material which is indispensable for exerting the required magnetic attraction on the sheet metal, avoiding the use of ferrite which would subsequently remain inactive. It may be calculated that thus the quantity of ferrite may be reduced by about half compared to that normally used according to the state of the art. This advantage has a positive effect both on the manufacturing costs and weight of the manufactured article to which the sheet or panel is applied and on the soundproofing performance of the said sheet.

According to the invention it is also envisaged applying the sheet or panel thus formed as a vibration-damping element in any suitable application other than the motor car sector, such as for example in the manufacture of washing machines.

1. Method for forming a vibration-damping sheet or panel to be joined to a sheet metal element, such as the bodywork of a motor vehicle, this sheet or panel being formed using a plurality of materials including at least a material having vibration-damping properties and a magnetic material, characterized in that it comprises the stages of forming a first layer which is operationally intended to come into contact with said sheet metal and in which substantially all of said magnetic material is included, forming a second layer comprising all or part of said material with vibration-damping properties and joining together said layers so as to form said sheet or panel.

2. Method according to claim 1, characterized in that said material with vibration-damping properties comprises bitumen.

3. Method according to claim 2, characterized in that said material with vibration-damping properties comprises bitumen and an inert filler.

4. Method according to claim 1, characterized in that said material with vibration-damping properties comprises one or more additives chosen from among elastomers, plastomers, resins and oils.

5. Method according to claim 1, characterized in that said material with vibration-damping properties is a plastic material such as polyurethane, on its own or mixed with other components.

6. Method according to claim 3, characterized in that said material with vibration-damping properties comprises an inert filler chosen from among mica, kaolin, talc, wood or cork dust, textile fibre, or mixtures thereof.

7. Method according to claim 1, characterized in that said magnetic material is chosen from among any suitable magnetizable ferrite, or permanent-magnet powder, on its own or mixed with other substances such as, for example, metal oxides.

8. Method according to claim 1, characterized in that said first and second layer are joined together by means of calendering.

9. Method according to claim 1, characterized in that said first and second layer are joined together by means of an adhesive.

10. Method according to claim 1, characterized in that said second layer is formed in a mould.

11. Method according to claim 1, characterized in that said second layer is formed by means of spraying onto the first layer.

12. Method according to claim 1, characterized in that the first layer containing the magnetic material is formed or cut into strips which are joined to the said second layer in a spaced arrangement.

13. Method according to claim 1, characterized in that the two layers are formed by means of extrusion and then joined together, or formed by means of co-extrusion.

14. Layer suitable for forming the external layer of a vibration-damping element or panel facing a sheet metal element, such as the bodywork of a motor vehicle, characterized in that it includes magnetic material in a quantity equal to substantially all of the magnetic material included in the overall composition of said sheet or panel.

15. Strip formed by a layer according to claim 14.

16. Vibration-damping sheet or panel to be joined to a sheet metal element, such as the bodywork of a motor vehicle or a washing machine, characterized in that it comprises at least said two layers formed with the method according to claim 1.
